(19) United States
(12) Patent Application Publication
(10) Pub. No.: US 2025/0076184 A1
(43) Pub. Date: Mar. 6, 2025

(54) DEFECT INSPECTION METHOD AND APPARATUS FOR ELECTRONIC DEVICES

(71) Applicant: ASMPT Singapore Pte. Ltd., Singapore (SG)

(72) Inventors: Yilong GUO, Chengdu City (CN); Peiliang ZHANG, Chengdu City (CN); Dong YANG, Chengdu City (CN)

(21) Appl. No.: 18/811,865

(22) Filed: Aug. 22, 2024

(30) Foreign Application Priority Data
Aug. 30, 2023 (CN) 202311108522.9

(51) Int. Cl. G01N 21/17; G01N 21/95

(52) U.S. Cl. CPC G01N 21/1702; G01N 21/9505; G01N 2021/1706

(57) ABSTRACT

Method for inspecting a semiconductor package includes the steps of generating and directing an excitation laser beam toward an excitation area on a first side of the semiconductor package so as to generate ultrasonic vibration in the semiconductor package, generating and directing a measurement laser beam toward a measurement area on a second side of the semiconductor package, wherein the first and second sides are opposite to each other, and detecting the measurement laser beam reflected from the measurement area with a vibration detector to measure the ultrasonic vibration generated by the excitation laser beam, thereby inspecting a quality of the semiconductor package.

### FIELD OF THE INVENTION

The invention is generally related to automated inspection of defects or quality inconsistencies in electronic devices such as semiconductor packages, and in particular to a method and an apparatus for inspecting electronic devices to enable non-contact medium-free in-line defect inspection during a manufacturing process for said electronic devices.

### BACKGROUND

During the manufacture of electronic devices such as semiconductor packages, various defects may arise in the semiconductor packages, making it essential to have an effective and efficient solution for quality or defect inspection to ensure that the quality of the finished electronic devices is acceptable. While non-destructive offline defect inspection methods have been adopted for automatic inspection after manufacturing, there is a need for an in-line defect inspection solution to prevent defective devices from being transferred to a subsequent production process, provide timely feedback on defects to enhance production process control, increase production yield, and reduce resource wastage.

In the semiconductor industry, an in-line inspection method for packaging should be non-destructive, pollution-free, and have high-speed scanning capability with high throughput, as the quality of the electronic devices is very sensitive to humidity and contamination. However, prior art inspection devices are inadequate for this purpose. For example, using conventional X-ray inspection equipment with limited operational lifespans for in-line examination will lead to increased costs associated with radiation protection, as well as a decrease in inspection speed. Similarly, the effectiveness of piezoelectric ceramics and other ultrasonic generators is constrained by the necessity of a transmission medium to carry ultrasonic signals. However, introducing such a medium could potentially undermine the quality and dependability of the inspected electronic devices.

Some non-contact medium-free ultrasonic measurement methods have been proposed to conduct quality inspection for electronic devices. However, these methods have limited accuracy due to the slow ultrasonic propagation speed through the air, resulting in lower resolution. Furthermore, the inspection throughput will be restricted by the need for frequent movements of the inspected electronic device for measuring the entire device which is necessitated by a limited effective measurement area.

For example, a laser ultrasonic measurement method generates ultrasound by inducing sudden thermal deformation on a target surface of a die included in an electronic device and uses an optical Doppler effect to measure ultrasonic vibrations on the target surface in a non-contact manner, thereby inspecting defects in the electronic device based on the measurement results. However, as both the excitation laser beam and the measurement laser beam in this method (hereinafter, also referred to as a “reflection detection method”) are directed at the same target surface of the semiconductor die, there is a risk of damaging the surface of the semiconductor die, which is sensitive. Also, the accuracy of quality inspection may be affected since the reflective laser beams may have low sensitivity to defects in the electronic device.

It would therefore be beneficial to provide an in-line inspection solution for electronic devices that can address at least some of the issues faced by conventional defect inspection methods.

### SUMMARY OF THE INVENTION

It is thus an object of this invention to seek to provide an effective and efficient in-line defect inspection method for electronic devices during manufacturing of the electronic devices.

According to a first aspect of the invention, there is provided a method for inspecting a semiconductor package which includes generating and directing an excitation laser beam toward an excitation area on a first side of the semiconductor package so as to generate ultrasonic vibration in the semiconductor package, generating and directing a measurement laser beam toward a measurement area on a second side of the semiconductor package, the first side and the second side being opposite to each other, and detecting the measurement laser beam reflected from the measurement area to measure the ultrasonic vibration generated by the excitation laser beam, thereby inspecting a quality of the semiconductor package.

With the proposed inspection method, the excitation laser beam and the measurement laser beam are targeted onto two opposite sides of the semiconductor package such that the ultrasonic vibration in the semiconductor package generated by the excitation laser beam is detected by a transmission-based detection method instead of the reflection detection method used in the prior art. The transmission-based detection method means that the ultrasonic vibration generated by the excitation laser beam on one side of the semiconductor package is transmitted to the opposite side of the semiconductor package and is detected by the measurement laser beam directed to such opposite side. This can prevent damage to a sensitive surface of the semiconductor package, since the excitation laser beam may be directed toward a less sensitive or non-sensitive surface of the semiconductor package, e.g., onto a substrate.

The proposed method may be used to inspect for various defects formed after bonding a die to a substrate included in the semiconductor package. In some embodiments, the first side of the semiconductor package may include a surface of a substrate comprised in the semiconductor package, and the second side of the semiconductor package may include a surface of a semiconductor die that has been attached to the substrate and/or a surface of an interconnect that has been bonded to the die. Accordingly, inspecting the semiconductor package may include inspecting for quality inconsistencies in the semiconductor package introduced during the manufacturing process, wherein the quality inconsistencies may include one or more of the following defects in the semiconductor package: a void and/or a delamination defect formed in an adhesive layer between the die and the substrate comprised in the semiconductor package, a void defect formed in an adhesive layer between the die and the interconnect bonded to the die comprised in the semiconductor package, a crack formed in the die, and uneven distribution of an adhesive layer between the die and the substrate comprised in the semiconductor package.

In another embodiment, the proposed method may be used to inspect for defects formed after the molding of the semiconductor package. The first and second sides of the semiconductor package may include two opposite surfaces of a molded enclosure of the semiconductor package. The defects formed during the molding process may include a crack formed in the molded enclosure. Accordingly, inspecting the semiconductor package further includes inspecting for a crack formed in the molded enclosure.

In order to conduct a comprehensive quality inspection for a semiconductor package, the excitation laser beam in some embodiments may be sequentially directed toward a plurality of excitation areas on the first side of the semiconductor package. For example, when the first side includes a surface of a substrate comprised in the semiconductor package, the plurality of excitation areas may substantially cover the entire surface. Accordingly, the measurement laser beam may be directed to a fixed measurement area or a plurality of corresponding measurement areas on the second side.

Alternatively, the measurement laser beam in some embodiments may be sequentially directed toward a plurality of measurement areas on the second side of the semiconductor package. For example, when the second side includes a surface of a die attached to the substrate, the plurality of measurement areas may substantially cover the entire surface of the die. Accordingly, the excitation laser beam may be directed to a fixed excitation area or a plurality of excitation areas on the first side.

Each measurement area on the second side may have a predetermined spatial relationship with a corresponding excitation area on the first side of the semiconductor package. Preferably, to further improve the accuracy of the inspection, each measurement area on the second side and the corresponding excitation area on the first side may be located opposite to and coextensive with each other. In other words, each measurement area has a corresponding excitation area located directly opposite it, with the same shape and dimensions.

In some embodiments of the invention, the step of detecting the measurement laser beam may include detecting frequency changes of the measurement laser beam at a plurality of measurement areas so as to inspect for quality inconsistencies in the semiconductor package during the manufacturing process. These quality inconsistencies are deducible from the detected frequency changes. The vibration detector may include a vibrometer.

According to a second aspect of the invention, there is provided an apparatus for inspecting a semiconductor package during manufacturing the semiconductor package. The apparatus includes an excitation laser assembly operative to generate and direct an excitation laser beam toward an excitation area on a first side of the semiconductor package so as to generate ultrasonic vibration in the semiconductor package, a measurement laser assembly operative to generate and direct a measurement laser beam toward a measurement area on a second side of the semiconductor package opposite to the first side, the excitation laser assembly and the measurement laser assembly being positioned on opposite sides of the semiconductor package, and a vibration detector operative to detect the measurement laser beam reflected from the second side of the semiconductor package to measure the ultrasonic vibration generated by the excitation laser beam, thereby inspecting a quality of the semiconductor package.

The vibration detector and the measurement laser assembly may utilize a common optical system to make the whole apparatus more compact. The common optical system may include a galvanometer and an f-theta lens. The galvanometer is configured and operative to direct the measurement laser beam toward the measurement area on the second side of the semiconductor package and to direct the measurement laser beam reflected from the measurement area toward the vibration detector through the f-theta lens. In some embodiments, the common optical system may further include a polarizing beam splitter and a quarter wave plate, which are configured to direct the measurement laser beam from the measurement laser assembly toward the galvanometer and direct the measurement laser reflected from the measurement area toward the vibration detector.

The inspection apparatus may further include a control system configured to record detection results from the vibration detector and to analyze the detection results to identify quality inconsistencies in the semiconductor package.

The control system may include a control module communicably connected to the excitation laser assembly and/or the measurement laser assembly. The control module is configured to send control signals to the excitation laser assembly and/or the measurement laser assembly to adjust the direction of the excitation laser beam and/or the direction of the measurement laser beam. The control system may further include a controller clock for synchronizing operations in the excitation laser assembly and the measurement laser assembly.

These and other features, aspects, and advantages will become better understood with regard to the description section, appended claims, and accompanying drawings.

### BRIEF DESCRIPTION OF THE DRAWINGS

Embodiments of the present invention will now be described, by way of example only, with reference to the accompanying drawings, in which:

FIG. 1 is a schematic side view of an in-line apparatus for inspecting semiconductor packages according to one embodiment of the invention;

FIG. 2 is a flowchart illustrating an in-line method for inspecting a semiconductor package according to certain embodiments of the invention;

FIG. 3A shows a cross-sectional side view of a semiconductor package that includes voids formed in an adhesive layer between a substrate and a die attached to the substrate and in an adhesive layer between the die and a chip bonded to the die;

FIG. 3B is a cross-sectional side view of a semiconductor package that includes a delamination defect in the adhesive layer between a substrate and a die attached to the substrate;

FIG. 3C is a cross-sectional side view of a semiconductor package that includes a crack present in a die included in the semiconductor package;

FIG. 4 shows cross-sectional side views of four semiconductor packages, each containing a standard adhesive layer, an adhesive layer that is too thick, an adhesive layer that is too thin, and an unevenly distributed adhesive layer respectively;

FIG. 5A shows a cross-sectional side view of a semiconductor package where cracks are present in a molded enclosure.

FIG. 5B shows waveforms that are respectively obtained at different measurement areas on a bottom surface of the molded enclosure shown in FIG. 5A.

FIG. 6 is a flowchart illustrating a method for inspecting a semiconductor package according to one embodiment of the invention.

In the drawings, like parts are denoted by like reference numerals.

### DETAILED DESCRIPTION

Before discussing embodiments in any more detail, first an overview will be provided. Embodiments of the invention provide a method and an apparatus for in-line inspection of electronic devices. In this invention, an excitation laser beam and a measurement laser beam are respectively directed onto two opposite sides of a semiconductor package. The excitation laser beam is used to excite ultrasonic vibrations in the semiconductor package such that when the measurement laser beam is reflected from the semiconductor package, frequency changes in the measurement laser caused by various quality inconsistencies of the semiconductor packages can be detected by a vibration detector and used for identifying such inconsistencies, such as void and delamination defects formed in an adhesive layer between a die and a substrate, a crack formed in a die, and/or uneven distribution of the adhesive layer between a die and a substrate. Further, at least one of the excitation and measurement laser beams may be directed to different areas on the semiconductor package. Thus, the resulting vibration waveforms may be compared across at least one eigenvalue of the plurality of areas to identify and quantify any defects or imperfections in the semiconductor package.

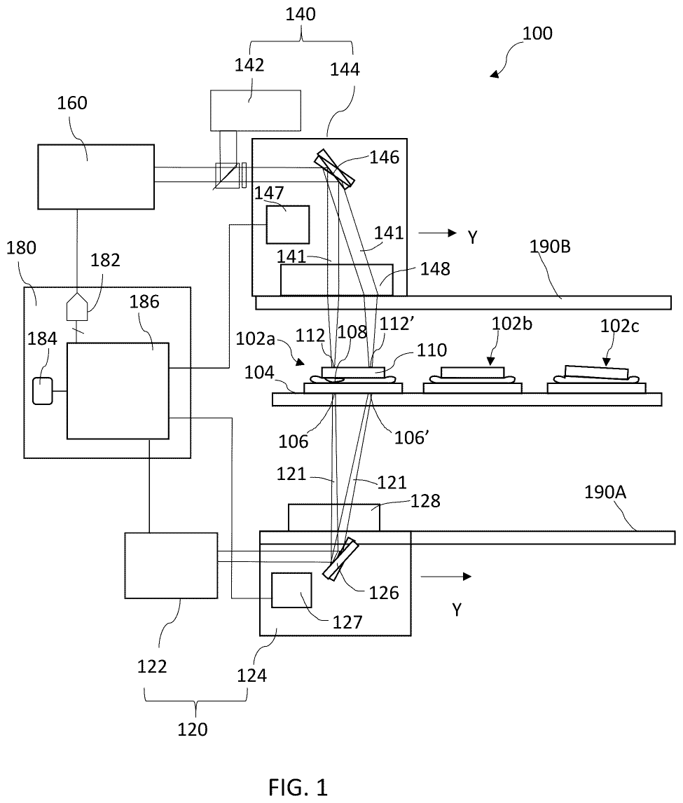

FIG. 1 is a schematic side view of an in-line apparatus 100 for inspecting semiconductor packages 102a-102c according to one embodiment of the invention. The apparatus 100 includes an excitation laser assembly 120, a measurement laser assembly 140, a vibration detector 160 and a control system 180. Referring to FIG. 1, the excitation laser assembly 120 and the measurement laser assembly 140 are positioned on opposite sides of the semiconductor package 102a for inspecting the semiconductor package 102a. Each of the semiconductor packages 102a-102c includes a substrate 104 and a die 110 attached to the substrate 104.

The excitation laser assembly 120 is configured and operative to generate an excitation laser beam 121 and direct the excitation laser beam 121 toward a bottom side (or first side) of the semiconductor package 102a. The bottom side includes a bottom surface of the substrate 104 comprised in the semiconductor package 102a. The excitation laser beam is directed at an excitation area 106 on the bottom surface of substrate 104. Typically, the excitation laser beam 121 is a nanosecond-level pulse of laser energy that can be absorbed by the excitation area 106 within a micrometer range in nanoseconds, thereby generating stress from deformation of the excitation area 106, which propagates as ultrasonic waves in the semiconductor package 102a for a short time period. As shown in FIG. 1, excitation area 106 is located directly below a void defect 108. When the ultrasonic waves pass through the void defect 108, their waveforms will change due to the lower acoustic resistance of the material in the void defect 108. Such changes can be measured via the measurement laser assembly 140.

Referring to FIG. 1, the excitation laser assembly 120 may include an excitation laser generator 122 and an excitation beam steering device 124. The excitation laser generator 122 is operative to generate the excitation laser beam 121 for actuating ultrasonic vibrations in the semiconductor package 102a. The excitation beam steering device 124 is configured to direct the excitation laser beam 121 to excitation areas 106 on the bottom surface of the substrate 104.

The excitation beam steering device 124 may be formed by an optical system. For example, the excitation beam steering device 124 may include a galvanometer 126 and an f-theta lens 128. The galvanometer 126 is configured and operative to direct the excitation laser beam 121 from the excitation laser generator 122 toward an excitation area 106 on the bottom surface of the substrate 104 through the f-theta lens 128. When the excitation laser beam 121 targets the excitation area 106, an excitation ultrasonic laser spot will be generated at the excitation area 106.

The excitation beam steering device 124 may further include a galvanometer driver 127. The galvanometer driver 127 may be operative to alter the direction of the excitation laser beam 121 by adjusting the orientation of the galvanometer 126. Consequently, the position of the excitation area 106 on the bottom surface of the substrate 104 can be changed. To enhance the accuracy and thoroughness of defect inspection, the excitation beam steering device 124 may be operative to adjust the direction of the excitation laser beam 121 so as to sequentially direct the excitation laser beam 121 to a plurality of excitation areas on the first side of the semiconductor package 102a. The plurality of excitation areas may cover the entire bottom surface of the substrate 104 for a comprehensive inspection. It should be noted that the excitation beam steering device 124 may be formed by different optical systems as long as the optical systems can be used to direct the excitation laser beam toward a target area on the first side of the semiconductor package 102a.

The apparatus 100 may further include a linear motor 190A which is configured to move the excitation laser assembly 120 to a position directly below a semiconductor package to be inspected, e.g., any one of the semiconductor packages 102a to 102c.

The measurement laser assembly 140 is configured and operative to generate a measurement laser beam 141 and direct the measurement laser beam 141 toward a top side (or second side) of the semiconductor package 102a. The top side of the semiconductor package 102a includes a top surface of a semiconductor die 110 mounted on the substrate 104. The measurement laser beam 141 is directed to a measurement area 112 on the top surface of the die 110. As shown in FIG. 1, the measurement area 112 is located directly opposite to the excitation area 106 on the bottom surface of the substrate 104 in this embodiment. The measurement laser beam 141 reflected by the measurement area 112 is then directed to the vibration detector 160 through the same optical system.

Referring to FIG. 1, the measurement laser assembly 140 may include a measurement laser generator 142 and a measurement beam steering device 144. The measurement laser generator 142 is configured and operative to generate a measurement laser beam for inspecting the semiconductor package 102a. The measurement beam steering device 144 is configured to direct the measurement laser beam 141 from the measurement laser generator 142 toward the second side of the semiconductor package 102a. In this embodiment, the second side of the semiconductor package 102a includes the top surface of each die 110.

The measurement beam steering device 144 may be formed by an optical system for directing the measurement laser beam toward the second side of the semiconductor package 102a. For example, the measurement beam steering device 144 may include a galvanometer 146 and an f-theta lens 148. The galvanometer 146 is configured and operative to direct the measurement laser beam 141 from the measurement laser generator 142 toward the second side of the semiconductor package 102a through the f-theta lens 148. The measurement laser beam targets a measurement area on the top surface of the die 110. The measurement beam steering device 144 may further include a galvanometer driver 147. The direction of the measurement laser beam may be altered by adjusting the orientation of the galvanometer 146 via the galvanometer driver 147. Consequently, the measurement area on the top surface of the die 110 can also be changed.

To enhance the accuracy and thoroughness of defect inspection, the measurement beam steering device 144 may be operative to adjust the direction of the measurement laser beam 141 so as to sequentially direct the measurement laser beam 141 to a plurality of measurement areas on the top surface of the die 110. The measurement areas may be arranged to cover the entire top surface of the die 110 during the measurement. Each of the plurality of measurement areas on the top surface of the die 100 may have a predetermined spatial relationship with a corresponding excitation area on the bottom surface of the substrate 104. In one example, the excitation laser beam 121 may be directed toward a fixed excitation area on the bottom surface of the substrate 104, while the measurement laser beam 141 may be directed to the plurality of measurement areas that may cover the entire top surface of the die 100. Alternatively, the excitation laser beam 121 may be directed toward a plurality of excitation areas that may cover the entire surface of the substrate 104, while the measurement laser beam is directed toward a fixed measurement area on the top surface of the die 100. Preferably, each measurement area on the top surface of the die 100 and the corresponding excitation area on the bottom surface of the substrate 104 are located opposite to and coextensive with each other. In other words, when the excitation laser beam 121 is directed to a predetermined excitation area on the bottom surface of the substrate 104, the measurement laser beam 141 is accordingly directed toward a measurement area that is located directly opposite to the predetermined excitation area on the top surface of the die 110, and has same shape and dimensions. With such an arrangement, the accuracy of defect inspection can be further improved.

The apparatus 100 may further include a linear motor 190B which is configured to move the measurement laser assembly 140 to a position directly above a semiconductor package to be inspected, e.g., any one of the semiconductor packages 102a to the semiconductor package 102c.

The vibration detector 160 is configured and operative to detect the measurement laser beam 141 reflected from the measurement area 112 to measure the ultrasonic vibration at the measurement area 112 that is generated by the excitation laser beam 121 directed to the excitation area 106. The vibration detector 160 may be operative to detect the frequency changes of the measurement laser beam 141 reflected from the measurement area 112 and convert the frequency changes to changes of voltage amplitude formed by multi-beam interference. The vibration detector 160 may include a vibrometer. The vibration detector 160 is communicably connected to the control system 180 to transfer the detection results to the control system 180.

The control system 180 is configured to record the detection results from the vibration detector 160, and to identify and quantify any quality inconsistencies of the semiconductor package 102a based on the recorded detection results. The control system 180 may be further configured to synchronize the excitation laser assembly 120, the measurement laser assembly 140, and the vibration detector 160. It also sends control signals to the respective galvanometer drivers 127 and 147, in order to adjust the directions of the respective galvanometers 126, 146.

Referring to FIG. 1, the control system 180 may include a digital-to-analog converter 182, a controller clock 184 and a control module 186. The digital-to-analog converter 182 may be configured to generate waveform diagrams based on photocurrent signals received from the vibration detector 160. The controller clock 184 is configured to synchronize the operations of the excitation laser assembly 121, the measurement laser assembly 141 and the vibration detector 160. The control module 186 is configured to send control signals to the galvanometer drivers 127, 147 so as to adjust the deflection angles of the galvanometers 126, 146 according to preset rules. The preset rules may define one or a set of specific values for adjusting the deflection angle of each galvanometer during the inspection of a semiconductor package. The control module 186 may also record the waveform diagrams generated by the digital-to-analog converter 182 and transfer the recorded information to a server computer that is communicably connected thereto.

In this embodiment, the control system 180 may be operative to control the galvanometer driver 127 to adjust the deflection angle of the galvanometer 126 so that the excitation area will be able to traverse the entire bottom surface of the substrate 104. Accordingly, the control system 180 may also control the galvanometer driver 147 to adjust the deflection angle of the galvanometer 146 so that the measurement area can transverse the entire top surface of the die 110. Preferably, the galvanometers 126 and 146 are adjusted accordingly such that the excitation area on the top surface of the die 110 and the corresponding measurement area on the bottom surface of the substrate 104 are located directly opposite to each other. However, it should be appreciated by a person skilled in the art that for certain embodiments, it may not be essential for the excitation and measurement areas to cover the entire surfaces on which they may be directed.

After the semiconductor package 102a has been inspected, the excitation laser assembly 120 and the measurement laser assembly 140 may be driven by the linear motors 190A and 190B respectively to move to a position directly above or below the next semiconductor package to be inspected, e.g., the semiconductor package 102b or the semiconductor package 102c, to conduct similar inspection processes. As shown in FIG. 1, the excitation laser assembly 120, and the measurement laser assembly 140 may be moved in a horizontal direction Y.

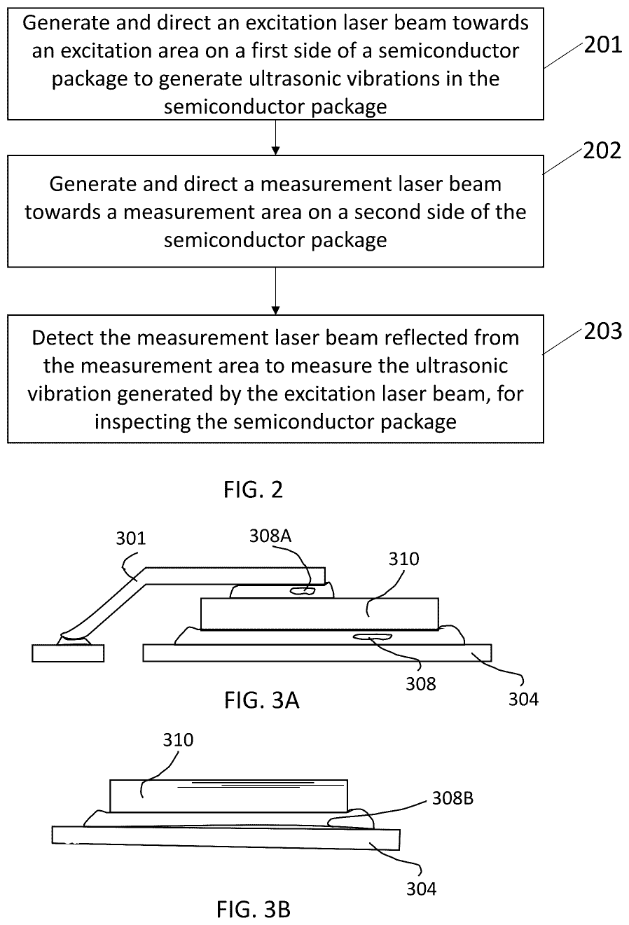

FIG. 2 is a flowchart illustrating a method for inspecting a semiconductor package during manufacturing the semiconductor package according to certain embodiments of the invention. The method includes the following steps:

At Step 201, an excitation laser beam is generated and directed toward an excitation area on a first side of the semiconductor package so as to generate ultrasonic vibrations in the semiconductor package.

At Step 202, a measurement laser beam is generated and directed toward a measurement area on a second side of the semiconductor package. The first and second sides are opposite to each other.

At Step 203, the measurement laser beam reflected from the measurement area is detected by a vibration detector to measure the ultrasonic vibration generated by the excitation laser beam, for inspecting the semiconductor package.

In order to inspect for possible defects formed between the first and second sides of the semiconductor package, at least one of the excitation laser beam and the measurement laser beam may be directed toward a plurality of different areas on the first and/or second sides of the semiconductor package sequentially. The plurality of different areas on the first and/or second sides of the semiconductor package may cover the entire target surface(s) on the first and/or second sides. In certain embodiments, the measurement laser beam is sequentially directed toward a plurality of measurement areas on the second side of the semiconductor package, corresponding to changes in positions of the excitation beam relative to the plurality of excitation areas such that each measurement area on the second side has a predetermined spatial relationship with a corresponding excitation area on the first side of the semiconductor package. Preferably, the predetermined spatial relationship may refer to each measurement area on the second side being located directly opposite to a corresponding excitation area and having the same shape/pattern and dimensions as the corresponding excitation area. Referring to FIG. 1, the measurement area 112 and the excitation area 106 are located directly opposite to each other and are coextensive with each other.

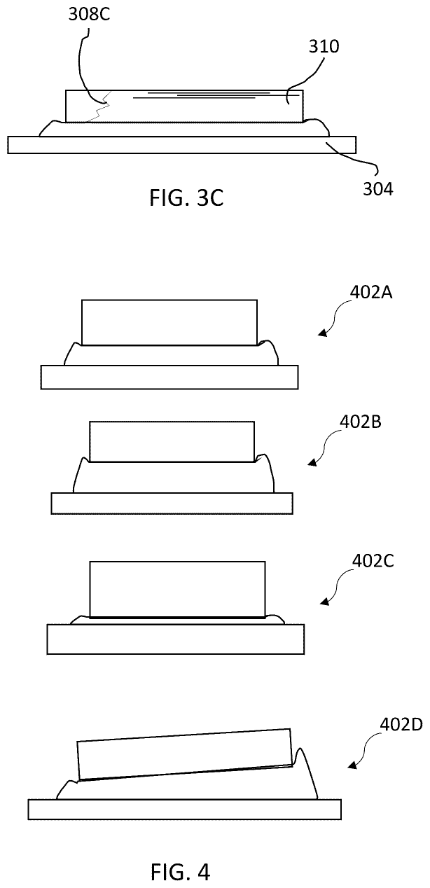

In some embodiments, the above method may be used to inspect for quality inconsistencies present between a substrate and a die attached to the substrate or present within the die itself. In these embodiments, the first side of the semiconductor package may include a bottom side of the substrate and the second side of the semiconductor package may include a top surface of the die attached to the substrate. The quality inconsistencies that may be identified include but are not limited to the following defects:
Voids formed in an adhesive layer between the substrate and die
   For example, a void 108 formed in an adhesive layer between the die 110 and the substrate104 as shown in FIG. 1 and a void 308 formed in the adhesive layer between the substrate 304 and the die 310 as shown in FIG. 3A.
Delamination defects in an adhesive layer between the substrate and die
   For example, a delamination defect 308B formed in the adhesive layer between a die 310 and a substrate 304 as shown in FIG. 3B. The delamination defect 308B that occurs in the adhesive layer may be due to delamination and/or separation of a solder material in the adhesive layer. Such delamination does not result in any loss of solder material. In the case of vibrations transmitted in the form of ultrasound, such interfaces will exhibit total reflection, and the characteristic values of the waveform will undergo significant changes, such as a noticeable decrease in a measured vibration waveform amplitude.
Crack defects formed in the die
   For example, a crack 308C is present in a die 310 attached to the substrate 304 as shown in FIG. 3C. This type of defect that exists inside a wafer is similar in principle a delamination defect, wherein any changes in mass density would be negligible. However, due to the vast difference in acoustic impedance between air and solid materials such as silicon, total reflection can be assumed. Therefore, significant changes can be identified from the characteristic values of the measured waveform when the crack 308C is present between the excitation area and the measurement area.
Uneven distribution of an adhesive layer or a thickness of an adhesive layer does not meet a desired or required standard.
   FIG. 4 shows side views of four semiconductor packages 402A-402D. In one semiconductor package 402A, both the distribution and thickness of the adhesive layer meet a predetermined standard. On the other hand, the other semiconductor packages 402B to 402D exhibit varying issues in relation to the adhesive layer, including excessive thickness, inadequate thickness and uneven distribution. For cases of excessive thickness or inadequate thickness of the adhesive layer, measurement at a single measurement area is enough for identifying this type of quality inconsistency. The measured vibration signal exhibits delay and a reduced bandwidth, indicating that the adhesive layer has excessive thickness. On the contrary, if the measured vibration signal exhibits advancement and increased bandwidth, this indicates that the adhesive layer may be too thin. In order to assess such uneven distribution of the adhesive layer, the measurement needs to be conducted at multiple spaced measurement areas.

When the method is used to inspect for quality inconsistencies in an interface between a die and a chip bonded to the die, the first side of the semiconductor package may include a bottom side of the substrate to which the die is attached, and the second side of the semiconductor package may include a top surface of the chip bonded to the die. Such quality inconsistencies may include but are not limited to voids formed in an adhesive layer between the die and the chip, such as the void 308A formed in the adhesive layer between an interconnect 301 (which may be in the form of a clip) and the die 310 as shown in FIG. 3A.

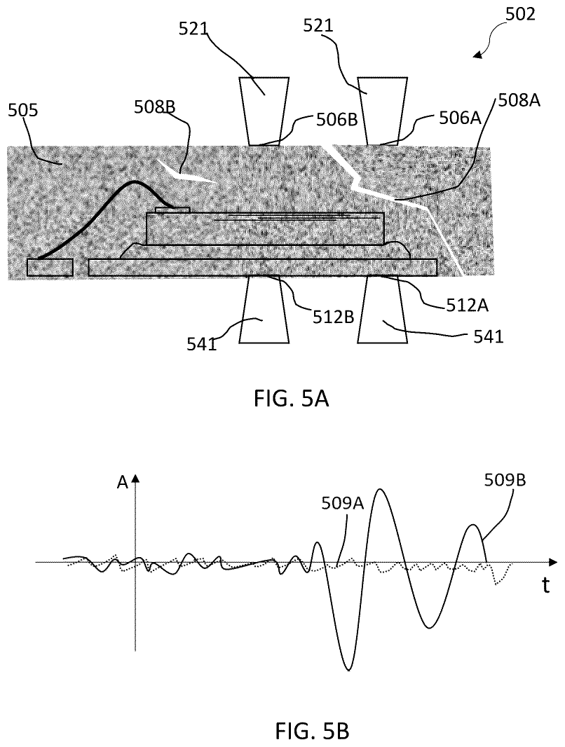

When the method is used to inspect for quality inconsistencies within a molded enclosure of a semiconductor package, the first and second sides of the semiconductor package would typically include two opposite surfaces of the molded enclosure. FIG. 5A shows a cross-sectional side view of a semiconductor package 502 that includes a molded enclosure 505. There are two cracks 508A, 508B present in the molded enclosure 305. When the method is used to inspect for these cracks 508A, 508B present in the molded enclosure 505, the excitation laser beam and the measurement laser beam may be directed toward the two opposite surfaces of the molded enclosure 505.

As shown in FIG. 5A, the excitation laser beam 521 is sequentially directed onto two different excitation areas 506A, 506B on a top surface of the molded enclosure 505. Accordingly, the measurement laser beam 541 is also sequentially directed onto two different measurement areas 512A, 512B on a bottom surface of the molded enclosure 505. The excitation area 506A and measurement area 512A are located directly opposite to each other, and the excitation area 506B and measurement area 512B are located directly opposite to each other. A line passing through the excitation area 506A and measurement area 512A does not encounter any cracks in the molded enclosure 505, while the line passing through the excitation area 506B and measurement area 512B cuts across the crack 508A in the molded enclosure 505. It should be noted that the arrangement of the excitation laser beam and the measurement laser beam may be different in other embodiments. For example, the excitation laser beam 521 may be directed to the bottom surface and the measurement laser beam 541 may be directed to the top surface of the molded enclosure 505. In FIG. 5B, the waveforms 509A and 509B obtained at the measurement areas 512A and 512B, respectively, are indicated. The horizontal axis represents time (t), while the vertical axis represents the vibration amplitude of the waves (A). It can be observed from these two waveforms that they exhibit different vibration amplitudes. This difference is due to the occurrence of total reflection when the ultrasonic vibration generated by the excitation laser beam 521 passes through the crack 508A. Therefore, based on the waveforms generated by the inspection method and apparatus provided in the embodiments of the invention, any cracks in the molded enclosure 505 can be identified.

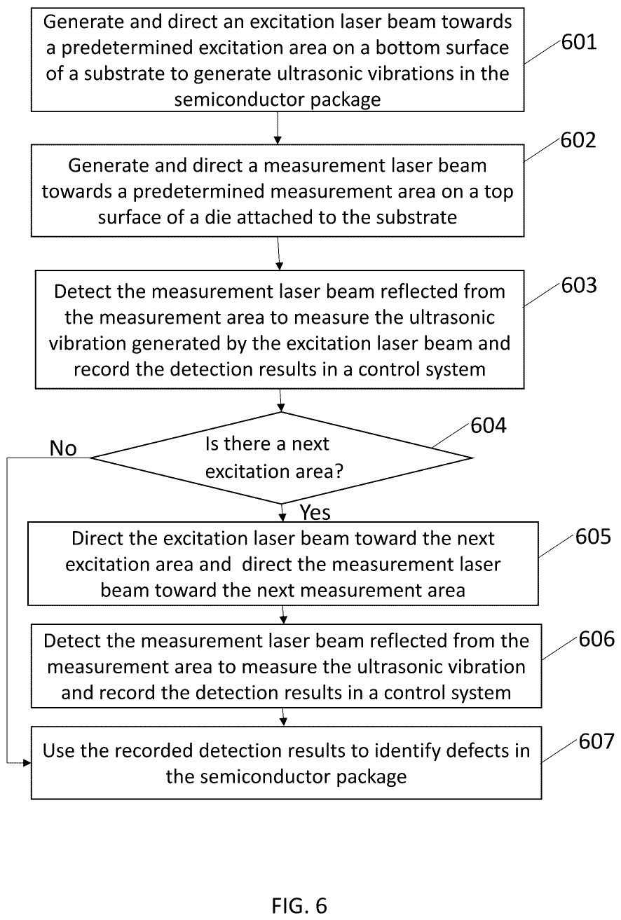

FIG. 6 is a flowchart illustrating a method for inspecting the semiconductor package 102aaccording to one embodiment of the invention.

At Step 601, an excitation laser beam 121 is generated and directed toward a predetermined excitation area on the bottom surface of the substrate 104 so as to generate ultrasonic vibrations in the semiconductor package 102a.

At Step 602, a measurement laser beam 141 is generated and directed toward a predetermined measurement area on the top surface of the die 110. The predetermined measurement area and the excitation area are located directly opposite to each other and have same shape and dimensions.

At Step 603, the measurement laser beam reflected from the measurement area is detected by a vibration detector to measure the ultrasonic vibrations generated by the excitation laser beam 121, and the detection results are recorded in a control system 180 for identifying any defects in the semiconductor package 102a.

At Step 604, if there is a next predetermined excitation area to be inspected on the bottom surface of the substrate 104, the process proceeds to step 605, otherwise the process proceeds to step 607.

At Step 605, the excitation laser beam 121 is directed toward the next excitation area on the bottom surface of the substrate 104 and the measurement laser beam 141 is directed toward a next measurement area on the top surface of the die 110. The next measurement area is located directly opposite to the next excitation area on the bottom surface of the substrate 104. For example, the excitation area 106′ and the measurement area 112′ shown in FIG. 1.

At Step 606, the measurement laser beam reflected from the next measurement area is detected by a vibration detector 160 to measure the ultrasonic vibrations generated by the excitation laser beam 121, and the detection results are recorded in a control system 180 for identifying the defects in the semiconductor package 102a.

At Step 607, the recorded detection results are used to identify defects in the semiconductor package 102a. For example, if the waveform generated based on the detected results obtained at one measurement area has an amplitude of vibration significantly lower than other measurement areas, it may be determined that a void or delamination defect could be present in the adhesive layer between the die 110 and the substrate 104.

With the methods and apparatus provided by embodiments of the invention, in-line defect inspection can be performed at different stages during the manufacture of a semiconductor package without requiring additional protection against radiation or a medium for ultrasound transmission. The semiconductor package may be inspected after a bonding process when a die is attached to the substrate, an interconnect is bonded to the die and/or after a molding process during which the electronic device is packaged within a molded enclosure. By using such inspection methods and apparatus, any quality inconsistencies or defects present in the semiconductor packages during different production stages can be promptly identified. This helps to prevent defective devices from being used in subsequent production stages, which ultimately improves the control of the production process. As a result, there is an increase in production yield while minimizing resource wastage. Further, since the excitation laser beam and measurement laser beam are directed toward opposite sides of the semiconductor package during the inspection, the shortcomings faced by conventional laser ultrasonic measurement methods are successfully addressed. Specifically, both the risk of damaging the sensitive surface of a die and the interference of the excitation laser beam and the measurement laser beam can be avoided, and a high detection resolution can be achieved without the need for a high measurement bandwidth. Also, the accuracy and efficiency of defect inspection can be improved due to the sensitivity of the transmitted laser beam to defects and the high propagation speed of the ultrasonic waves generated by the excitation laser beam in the semiconductor package. In addition, directions of the excitation and measurement laser beams are easily adjustable by altering the deflection angles of the optical components, such that the excitation areas and the measurement areas may cover the entire surfaces of their respective targets. This will further enhance the accuracy and thoroughness of the defect inspection, especially when each measurement area and its corresponding excitation area are located directly opposite to each other and have the same patterns and dimensions.

The invention described herein is susceptible to variations, modifications and/or additions other than those specifically described and it is to be understood that the invention includes all such variations, modifications and/or additions which fall within the spirit and scope of the above description.

1. A method for inspecting a semiconductor package, the method comprising:
generating and directing an excitation laser beam toward an excitation area on a first side of the semiconductor package so as to generate ultrasonic vibration in the semiconductor package,
generating and directing a measurement laser beam toward a measurement area on a second side of the semiconductor package, the first side and the second side being opposite to each other, and
detecting the measurement laser beam reflected from the measurement area with a vibration detector to measure the ultrasonic vibration generated by the excitation laser beam, thereby inspecting a quality of the semiconductor package.

2. The method according to claim 1, wherein the first side of the semiconductor package includes a surface of a substrate comprised in the semiconductor package.

3. The method according to claim 2, wherein the second side of the semiconductor package includes a surface of a die attached to the substrate, and/or a surface of an interconnect bonded to the die attached to the substrate.

4. The method according to claim 3, wherein the step of inspecting the semiconductor package comprises: inspecting for quality inconsistencies in the semiconductor package, wherein the quality inconsistencies include one or more of the following defects:
a void and/or a delamination defect formed in an adhesive layer between the die and the substrate,
a void defect formed in an adhesive layer between the die and the interconnect bonded to the die,
a crack formed in the die comprised in the semiconductor package, and
uneven distribution of an adhesive layer between the die and the substrate.

5. The method according to claim 1, wherein the first and second sides of the semiconductor package include two opposite surfaces of a molded enclosure of the semiconductor package.

6. The method according to claim 5, wherein the step of inspecting the semiconductor package comprises: inspecting for a crack formed in the molded enclosure.

7. The method according to claim 1, further comprising sequentially directing the excitation laser beam toward a plurality of excitation areas on the first side of the semiconductor package.

8. The method according to claim 1, further comprising sequentially directing the measurement laser beam toward a plurality of measurement areas on the second side of the semiconductor package.

9. The method according to claim 7, further comprising sequentially directing the measurement laser beam toward a plurality of measurement areas on the second side of the semiconductor package corresponding to changes in positions of the excitation laser beam relative to the plurality of excitation areas.

10. The method according to claim 9, wherein each measurement area on the second side of the semiconductor package has a predetermined spatial relationship with a corresponding excitation area on the first side of the semiconductor package.

11. The method according to claim 10, wherein each measurement area on the second side and a corresponding excitation area on the first side are located directly opposite to and coextensive with each other.

12. The method according to claim 9, wherein the step of detecting the measurement laser beam comprises: detecting frequency changes of the measurement laser beam at the plurality of measurement areas so as to inspect quality inconsistencies in the semiconductor package that are deducible from the detected frequency changes.

13. The method according to claim 1, wherein the vibration detector comprises a vibrometer.

14. An apparatus for inspecting a semiconductor package, the apparatus comprising:
an excitation laser assembly operative to generate and direct an excitation laser beam toward an excitation area on a first side of the semiconductor package so as to generate ultrasonic vibration in the semiconductor package, and
a measurement laser assembly operative to generate and direct a measurement laser beam toward a measurement area on a second side of the semiconductor package opposite to the first side, and
a vibration detector operative to detect the measurement laser beam reflected from the second side of the semiconductor package to measure the vibration generated by the excitation laser beam at the measurement area, thereby inspecting a quality of the semiconductor package.

15. The apparatus according to claim 14, wherein the excitation laser assembly and the measurement laser assembly are positioned on opposite sides of the semiconductor package.

16. The apparatus according to claim 14, wherein the vibration detector and the measurement laser assembly utilize a common optical system.

17. The apparatus according to claim 16, wherein the common optical system comprises a galvanometer and an f-theta lens, the galvanometer being configured and operative to direct the measurement laser beam toward the measurement area on the second side of the semiconductor package and to direct the measurement laser beam reflected from the measurement area toward the vibration detector through the f-theta lens.

18. The apparatus according to claim 17, wherein the common optical system further comprises a polarizing beam splitter and a quarter wave plate, which are configured to direct the measurement laser beam from the measurement laser assembly toward the galvanometer and direct the measurement laser reflected from the measurement area toward the vibration detector.

19. The apparatus according to claim 14, wherein the vibration detector comprises a vibrometer.

20. The apparatus according to claim 14, further comprising a control system configured to record detection results from the vibration detector and to analyze the detection results to identify quality inconsistencies in the semiconductor package.

21. The apparatus according to claim 20, wherein the control system includes a control module configured to send control signals to the excitation laser assembly and/or the measurement laser assembly to adjust the direction of the excitation laser beam and/or the direction of the measurement laser beam.
